(19) United States
(12) Patent Application Publication
(10) Pub. No.: US 2021/0397558 A1
(43) Pub. Date: Dec. 23, 2021

(54) STORAGE DEVICE AND OPERATING METHOD THEREOF

(71) Applicant: SK hynix Inc., Gyeonggi-do (KR)

(72) Inventors: Young Ick CHO, Gyeonggi-do (KR); Byeong Gyu PARK, Gyeonggi-do (KR)

(21) Appl. No.: 17/160,023

(22) Filed: Jan. 27, 2021

(30) Foreign Application Priority Data
Jun. 17, 2020 (KR) 10-2020-0073737

(51) Int. Cl. G06F 12/0873; G06F 3/06

(52) U.S. Cl. CPC G06F 12/0873; G06F 3/0679; G06F 2212/72; G06F 3/0604; G06F 2212/608; G06F 3/0655

(57) ABSTRACT

A storage device includes: a nonvolatile memory including a plurality of memory regions; and a controller configured to transmit to the host, when a normal read command and a logical address are received from a host, an upload request for uploading map data related to a first memory region corresponding to the logical address among the plurality of memory regions based on a map caching count related to the first memory region.

### CROSS-REFERENCE TO RELATED APPLICATION

The present application claims priority under 35 U.S.C. § 119(a) to Korean application number 10-2020-0073737, filed on Jun. 17, 2020, in the Korean Intellectual Property Office, which is incorporated herein by reference in its entirety.

### BACKGROUND

### 1. Technical Field

Various embodiments generally relate to an electronic device, and more particularly, to a storage device and an operating method thereof.

### 2. Related Art

Recently, a paradigm for a computer environment has transitioned to ubiquitous computing which enables a computer system to be used anytime and anywhere. Therefore, the use of portable electronic devices such as cellular phones, digital cameras, and notebook computers is rapidly increasing. Such portable electronic devices generally use a data storage device including a memory component. The data storage device is used to store data used in the portable electronic devices.

Such data storage device is advantageous in that stability and durability are superior due to the absence of a mechanical driving unit, information access speed is very fast, and power consumption is low. Examples of data storage devices having such advantages include a universal serial bus (USB) memory apparatus, a memory card having various interfaces, a universal flash storage (UFS) device, and a solid state drive.

### SUMMARY

Various embodiments are directed to providing a storage device capable of improving read performance by substantially preventing an unnecessary upload of map data and an operating method thereof.

In an embodiment, a storage device includes: a nonvolatile memory including a plurality of memory regions; and a controller configured to transmit to the host, when a normal read command and a logical address are received from a host, an upload request for uploading map data related to a first memory region corresponding to the logical address among the plurality of memory regions based on a map caching count related to the first memory region.

In an embodiment, an operating method of a storage device includes: receiving a normal read command and a logical address from a host; and transmitting, to the host, an upload request for uploading map data related to a first memory region corresponding to the logical address among the plurality of memory regions based on a map caching count related to the first memory region.

In an embodiment, a controller includes: a first core configured to serve as an interface with a host; a memory configured to store a map caching count table including a map caching count for each of a plurality of memory regions included in a nonvolatile memory; and a second core configured to determine, when a normal read command and a logical address are received from a host, whether to upload map data related to a first memory region corresponding to the logical address among the plurality of memory regions based on the map caching count related to the first memory region.

In an embodiment, a data processing device includes: a host configured to provide a read request together with a logical address; a device including a plurality of regions each configured to store data, at least one of the regions being configured to store plural map data pieces, each of which includes one or more map entries; and a controller configured to: control, in response to the read request, the device to read data from the regions by caching one or more of the plural map data pieces; count a number of caching operations performed for each of the plural map data pieces; and requesting, in response to the read request, the host to receive a map data piece, on which the number of caching operations performed is greater than a threshold, among the plural map data pieces, wherein the host is further configured to: receive the requested map data piece; and provide the controller with a subsequent request together with a logical address and a physical address included in the received map data piece.

In accordance with an embodiment, map data that is frequently stored in a map caching buffer and also frequently evicted is mainly uploaded to the host, so that it is possible to cover logical addresses in a range not covered by map data cached in the map caching buffer. As a consequence, an address translation operation is reduced, so that read performance can be improved.

Furthermore, in accordance with an embodiment, unnecessary map data is not uploaded, so that it is possible to substantially prevent processing delay of a read command due to frequent map data uploading.

### BRIEF DESCRIPTION OF THE DRAWINGS

FIG. 1 is a diagram illustrating a storage device in accordance with an embodiment.

FIG. 2 is a diagram illustrating a nonvolatile memory, such as that of FIG. 1.

FIG. 3 is a diagram illustrating an address mapping table.

FIG. 4 is a diagram illustrating a memory, such as that of FIG. 1.

FIG. 5 is a diagram illustrating a map caching count table, such as that of FIG. 4.

FIG. 6 is a diagram illustrating a process of transmitting a map data upload request to a host on the basis of a map caching count for each subregion in accordance with an embodiment.

FIG. 7 is a flowchart illustrating an operating method of the storage device in accordance with an embodiment.

FIG. 8 is a diagram illustrating a data processing system including a solid state drive (SSD) in accordance with an embodiment.

FIG. 9 is a diagram illustrating a controller, such as that illustrated in FIG. 8.

FIG. 10 is a diagram illustrating a data processing system including a data storage apparatus in accordance with an embodiment.

FIG. 11 is a diagram illustrating a data processing system including a data storage apparatus in accordance with an embodiment.

FIG. 12 is a diagram illustrating a network system including a data storage apparatus in accordance with an embodiment.

FIG. 13 is a diagram illustrating a nonvolatile memory device included in a data storage apparatus in accordance with an embodiment.

### DETAILED DESCRIPTION

Hereinafter, various embodiments are described with reference to the accompanying drawings. Throughout the specification, reference to “an embodiment,” “another embodiment” or the like is not necessarily to only one embodiment, and different references to any such phrase are not necessarily to the same embodiments.

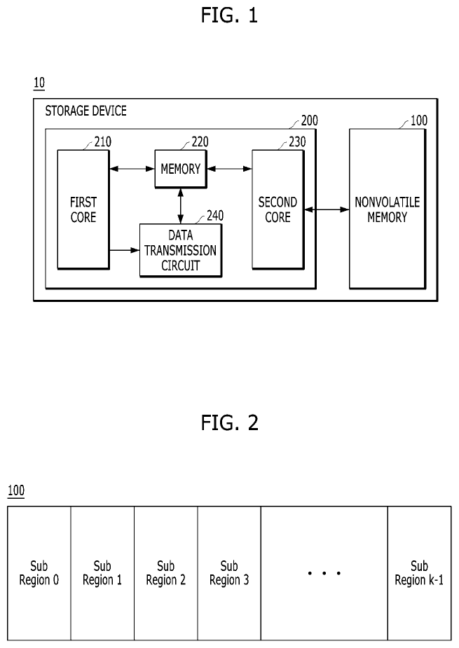

FIG. 1 is a diagram illustrating a configuration of a storage device 10 in accordance with an embodiment.

Referring to FIG. 1, the storage device 10 may store data that is accessed by a host (not illustrated) such as a cellular phone, an MP3 player, a laptop computer, a desktop computer, a game machine, a television, and/or an in-vehicle infotainment system. The storage device 10 may also be called a memory system.

The storage device 10 may be implemented with any of various types of storage devices according to an interface protocol connected to the host. For example, the storage device 10 may be configured as a multimedia card in the form of a solid state drive (SSD), an MMC, an eMMC, an RS-MMC, or a micro-MMC, a secure digital card in the form of an SD, a mini-SD, or a micro-SD, a universal serial bus (USB) storage device, a universal flash storage (UFS) device, a storage device in the form of a personal computer memory card international association (PCMCIA) card, a storage device in the form of a peripheral component interconnection (PCI) card, a storage device in the form of a PCI express (PCI-E) card, a compact flash (CF) card, a smart media card, and/or a memory stick.

The storage device 10 may be fabricated as any of various types of packages. For example, the storage device 10 may be fabricated as a package on package (POP), a system in package (SIP), a system on chip (SOC), a multi-chip package (MCP), a chip on board (COB), a wafer-level fabricated package (WFP), and/or a wafer-level stack package (WSP).

The storage device 10 may include a nonvolatile memory 100 and a controller 200.

The nonvolatile memory 100 may operate as a data storage medium of the storage device 10. The nonvolatile memory 100 may be configured as any of various types of nonvolatile memories, such as a NAND flash memory apparatus, a NOR flash memory apparatus, a ferroelectric random access memory (FRAM) using a ferroelectric capacitor, a magnetic random access memory (MRAM) using a tunneling magneto-resistive (TMR) film, a phase change random access memory (PRAM) using chalcogenide alloys, and/or a resistive random access memory (ReRAM) using a transition metal oxide, according to the type of memory cells in the nonvolatile memory 100.

For clarity, FIG. 1 illustrates the nonvolatile memory 100 as one block; however, the nonvolatile memory 100 may include a plurality of memory chips (or dies). The present invention may be equally applied to the storage device 10 including the nonvolatile memory 100 composed of the plurality of memory chips.

The nonvolatile memory 100 may include a memory cell array (not illustrated) having a plurality of memory cells arranged at respective intersection regions of a plurality of bit lines (not illustrated) and a plurality of word lines (not illustrated). The memory cell array may include a plurality of memory blocks and each of the plurality of memory blocks may include a plurality of pages.

For example, each memory cell of the memory cell array may be a single level cell (SLC) that stores one bit, a multi-level cell (MLC) capable of storing two bits of data, a triple level cell (TLC) capable of storing three bits of data, or a quad level cell (QLC) capable of storing four bits of data. The memory cell array may include at least one of the single level cell, the multi-level cell, the triple level cell, and the quad level cell. Also, the memory cell array may include memory cells having a two-dimensional horizontal structure or memory cells having a three-dimensional vertical structure.

FIG. 2 is a diagram illustrating the nonvolatile memory 100 of FIG. 1.

Referring to FIG. 2, the nonvolatile memory 100 may include a plurality of subregions, i.e., Sub Region 0 to Sub Region k−1, where k is a natural number greater than or equal to 2. Each of the plurality of subregions may be of the same size. In another embodiment, at least two of the subregions may have different sizes. Each of the plurality of subregions may include a plurality of memory blocks, each of which may include a plurality of pages; however, the present invention is not limited to that particular arrangement. Each subregion may be a sub-memory region.

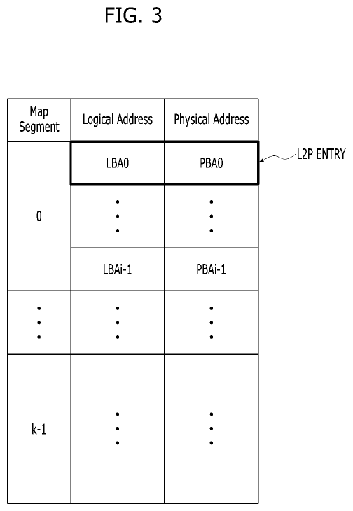

FIG. 3 is a diagram illustrating an address mapping table. Although not illustrated in FIG. 1, the nonvolatile memory 100 may include the address mapping table illustrated in FIG. 3.

Referring to FIG. 3, the address mapping table may include a plurality of map segments. Each of the plurality of map segments may include i logical addresses and i physical addresses mapped to the i logical addresses, respectively, where i is a natural number greater than or equal to 2. That is, each of the plurality of map segments may include i logical address to physical address (L2P) entries. Each L2P entry may include one logical address and one physical address mapped to the logical address.

The logical addresses included in each of the plurality of map segments may be sorted and arranged in an ascending or descending order; however, the present invention is not limited to that particular arrangement. A physical address mapped to a corresponding logical address may be updated to a new (different) physical address indicating where data related to the corresponding logical address is newly stored. Furthermore, one or more mapped logical and physical address pairs may be unmapped according to an unmap request from the host.

As illustrated in FIG. 3, a plurality of map segments, i.e., 0 to k−1, where k is a natural number greater than or equal to 2, may correspond to the plurality of subregions, i.e., Sub Region 0 to Sub Region k−1, illustrated in FIG. 2, respectively. For example, the map segment ‘0’ may correspond to Sub Region 0. Accordingly, the number of map segments and the number of subregions may be the same.

Furthermore, the map update operation may be performed on a map segment basis. The map update operation may include a mapping information change operation. The mapping information change may include changing a physical address mapped to a logical address to another physical address indicating another location where data related to the logical address is newly stored.

For example, when mapping information associated with logical address ‘LBA0’ is to be updated (or to be changed), all logical addresses LBA0 to LBAi−1 included in the map segment ‘0’ are read during the map update operation and are stored in a map update buffer (not illustrated) of a memory 220, and then mapping information of ‘LBA0’, that is, physical address PBA, may be changed.

Referring back to FIG. 1, the controller 200 may control overall operation of the storage device 10. The controller 200 may process requests received from the host. The controller 200 may generate control signals for controlling the operation of the nonvolatile memory 100 in response to the requests received from the host, and provide the generated control signals to the nonvolatile memory 100. The controller 200 may include a first core 210, the memory 220, a second core 230, and a data transmission circuit 240.

The first core 210 may serve as an interface between the host and the storage device 10 according to the protocol of the host. Therefore, the first core 210 may be called a protocol core. For example, the first core 210 may communicate with the host through any of universal serial bus (USB), universal flash storage (UFS), multi-media card (MMC), parallel advanced technology attachment (PATA), serial advanced technology attachment (SATA), small computer system interface (SCSI), serial attached SCSI (SAS), peripheral component interconnection (PCI), and PCI express (PCI-e) protocols.

The first core 210 may include a micro control unit (MCU) and a central processing unit (CPU).

The first core 210 may receive commands transmitted from the host and provide the received commands to the second core 230. For example, the first core 210 may queue the commands received from the host in a command queue (not illustrated) of the memory 220 and provide the second core 230 with information indicating that the commands are queued; however, the present invention is not limited to that particular arrangement.

The first core 210 may store data (for example, write data) received from the host in a write buffer (not illustrated) of the memory 220. Furthermore, the first core 210 may transmit data (for example, read data) stored in a read buffer (not illustrated) of the memory 220 to the host.

The memory 220 may be configured as a random access memory such as a static random access memory (SRAM) or a dynamic random access memory (DRAM); however, the present invention is not particularly limited thereto. Although FIG. 1 illustrates that the memory 220 is included in the controller 200, the memory 220 may be disposed outside the controller 200.

The memory 220 may be electrically connected to the first core 210 and the second core 230, and also may be physically so connected. The memory 220 may store firmware that is executed by the second core 230. Furthermore, the memory 220 may store data for executing the firmware, for example, meta data. That is, the memory 220 may operate as a working memory of the second core 230.

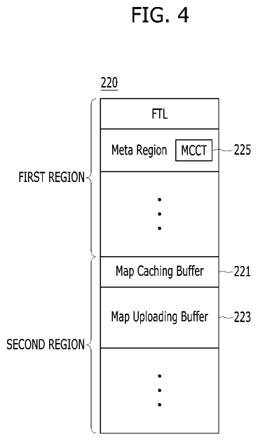

Furthermore, the memory 220 may be configured to include a write buffer for temporarily storing write data to be transmitted from the host to the nonvolatile memory 100 and a read buffer for storing read data to be transmitted from the nonvolatile memory 100 to the host. That is, the memory 220 may operate as a buffer memory. The internal configuration of the memory 220 is described below in detail with reference to FIG. 4.

The second core 230 may control overall operation of the storage device 10 by executing firmware or software loaded in the memory 220. The second core 230 may decrypt and execute a code type instruction or algorithm such as firmware or software. Therefore, the second core 230 may also be called a flash translation layer (FTL) core. The second core 230 may include a micro control unit (MCU) and a central processing unit (CPU).

The second core 230 may generate control signals for controlling the operation of the nonvolatile memory 100 on the basis of a command provided from the first core 210, and provide the generated control signals to the nonvolatile memory 100. The control signals may include a command, an address, an operation control signal and the like for controlling the nonvolatile memory 100. The second core 230 may provide the nonvolatile memory 100 with the write data temporarily stored in the memory 220, or store the read data received from the nonvolatile memory 100 in the memory 220.

The data transmission circuit 240 may operate according to the control signal(s) provided from the first core 210. For example, the data transmission circuit 240 may store the write data received from the host in the write buffer of the memory 220 according to the control signal(s) received from the first core 210. Furthermore, the data transmission circuit 240 may read the read data stored in the read buffer of the memory 220 and transmit the read data to the host according to the control signal(s) received from the first core 210. Furthermore, the data transmission circuit 240 may transmit map data stored in the memory 220 to the host according to the control signal received from the first core 210.

FIG. 4 is a diagram illustrating the memory 220 of FIG. 1.

Referring to FIG. 4, the memory 220, in accordance with an embodiment, may be divided into a first region and a second region; however, the present invention is not limited to this particular arrangement. For example, the first region of the memory 220 may store software (or firmware) interpreted and executed by the second core 230 and meta data and the like used when the second core 230 performs computation and processing operations. Furthermore, the first region of the memory 220 may store commands received from the host.

For example, software stored in the first region of the memory 220 may be the flash translation layer (FTL). The flash translation layer (FTL) may be executed by the second core 230, and the second core 230 may execute the flash translation layer (FTL) to control operation of the nonvolatile memory 100, and provide the host with device compatibility. Through the execution of the flash translation layer (FTL), the host may recognize and use the storage device 10 as a general storage device such as a hard disk.

The flash translation layer (FTL) may be stored in a system region (not illustrated) of the nonvolatile memory 100, and when the storage device 10 is powered on, the flash translation layer (FTL) may be read from the system region of the nonvolatile memory 100 and loaded in the first region of the memory 220. Furthermore, the flash translation layer (FTL) loaded in the first region of the memory 220 may also be loaded in a dedicated memory (not illustrated) disposed in or external to the second core 230.

The flash translation layer (FTL) may include modules for performing various functions. For example, the flash translation layer (FTL) may include a read module, a write module, a garbage collection module, a wear-leveling module, a bad block management module, a map module, and the like; however, the present invention is not limited to those particular modules. For example, each of the modules included in the flash translation layer (FTL) may be composed of a set of source codes for performing a specific operation (or function).

The map module may control the nonvolatile memory 100 and the memory 220 to perform operations related to the map data. The operations related to the map data may generally include a map update operation, a map caching operation, and a map upload operation; however, the present invention is not limited to those particular operations.

The map update operation may include changing the physical address of an L2P entry stored in the address mapping table (see FIG. 3) to another physical address indicating a location where data related to the logical address of that L2P entry is newly stored and storing the updated L2P entry with the changed physical address in the nonvolatile memory 100.

The map caching operation may include reading, from the nonvolatile memory 100, a map segment that includes an L2P entry corresponding to a logical address received with a read command from the host, and storing the map segment in a map caching buffer 221 of the memory 220. The map caching operation may be performed on a logical address frequently requested to be read and/or a logical address most recently requested to be read.

The map upload operation may include uploading map data stored in the nonvolatile memory 100 to the host. The map upload operation may be performed on a map segment basis. The map upload operation may include an operation of encoding the map data and an operation of transmitting the encoded map data to the host. For example, the second core 230 may read corresponding map data from the nonvolatile memory 100 in response to a map read command received from the host, encode the read map data, and store the encoded map data in a map uploading buffer 223 of the memory 220. In accordance with an embodiment, the map read command may be triggered by a map data upload request provided from the controller 200, which is described below. After storing the encoded map data in the map uploading buffer 223 of the memory 220, the second core 230 may transmit, to the first core 210, information indicating that the encoded map data is stored in the memory 220 and information on the storage position thereof. The first core 210 may provide the data transmission circuit 240 with a control signal for transmitting the encoded map data to the host on the basis of the information received from the second core 230, and the data transmission circuit 240 may transmit the encoded map data stored in the map uploading buffer 223 to the host according to the received control signal.

The first region of the memory 220 may include a meta region where meta data used for driving various modules included in the flash translation layer (FTL) is stored. The meta region may include a map caching count table (MCCT) 225 including a caching count for each map segment (and its corresponding subregion) of the nonvolatile memory 100. The map caching count may be managed by a map module executed by the second core 230.

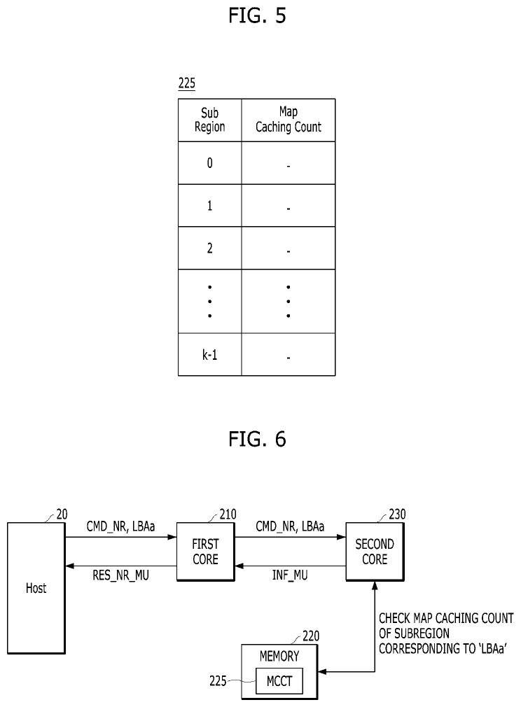

FIG. 5 is a diagram illustrating the map caching count table 225.

Referring to FIG. 5, the map caching count table 225 may include a subregion field identifying each of a plurality of subregions, i.e., Sub Region 0 to Sub Region k−1, and a map caching count field containing a map caching count for each of Sub Region 0 to Sub Region k−1. The map caching count for a given subregion may indicate the number of times by which a map segment corresponding to that subregions is read from the nonvolatile memory 100 and is stored in the map caching buffer 221 of the memory 220. That is, the map caching counts may indicate the number of times by which the map caching operation is performed for the map segments, respectively.

As described above, the map caching operation is performed on a logical address frequently requested to be read and/or a logical address most recently requested to be read. Then, the map segment subjected to the map caching operation is stored in the memory 220 of the storage device 10.

For example, when a map segment including a logical address received from the host together with a read command exists in the map caching buffer 221, an address translation operation of translating the received logical address to a physical address may be quickly performed. However, when the map segment including the logical address received from the host together with the read command does not exist in the map caching buffer 221, the map caching operation of reading the map segment including the received logical address from the nonvolatile memory 100 and storing the map segment in the map caching buffer 221 needs to be performed first. Thus, time it takes to perform the address translation operation may increase.

A map segment having a high map caching count may be frequently stored in the map caching buffer 221 and also frequently evicted. On the other hand, a map segment having a low map caching count may be retained in the map caching buffer 221 for a relatively long time.

When map data is uploaded from the storage device 10 to the host, the host may transmit the map data, uploaded from the storage device 10, together with a command to the storage device 10. When the command and the map data are received from the host, the storage device 10 may directly process the command without performing address translation because the map data includes a logical address and a physical address mapped to the logical address.

As described above, since a map segment having a high map caching count is frequently stored in the map caching buffer 221 and also frequently evicted, when the storage device 10 uploads such a map segment to the host, it is possible to cover logical addresses in a range not covered by map data cached in the map caching buffer 221. Accordingly, the time it takes to perform the address translation operation is reduced, so that read performance can be improved.

Furthermore, as described above, the map upload operation includes the operation of encoding the map data and the operation of transmitting the encoded map data to the host, and thus requires much time. When the storage device 10 unnecessarily uploads a lot of map data to the host, processing of read commands received from the host and queued in the memory 220 may be delayed. Therefore, select map data should be updated to the host at the appropriate time.

The map upload operation may be performed on the basis of the map read command received from the host. When a map data upload request is received from the storage device 10, the host may transmit the map read command to the storage device 10. In accordance with an embodiment, the map read command may be triggered by a map data upload request provided from the controller 200. That is, when the storage device 10 does not transmit the map data upload request to the host, the host may not provide the map read command to the storage device 10 and thus the storage device 10 may not perform the map upload operation.

Therefore, the controller 200 of the storage device 10 may determine whether, and if so when, to upload map data.

The controller 200 of the storage device 10 in accordance with the present embodiment may check a map caching count of a subregion corresponding to a logical address read-requested from the host, determine whether the map caching count of the subregion corresponding to the read-requested logical address is greater than or equal to a threshold count, and transmit, to the host, the map data upload request for a map segment (or corresponding subregion) corresponding to the read-requested logical address when the map caching count for that subregion is greater than or equal to the threshold count. The map data upload request may be transmitted by being included in a response to the read command received from the host.

FIG. 6 is a diagram illustrating a process of transmitting the map data upload request to the host on the basis of a map caching count for each subregion in accordance with an embodiment.

Referring to FIG. 6, when a host 20 transmits a normal read command CMD_NR and a logical address LBAa, the first core 210 of the controller 200 may receive the normal read command CMD_NR and the logical address LBAa and provide the second core 230 with the normal read command CMD_NR and the logical address LBAa. For example, the normal read command CMD_NR may be for reading user data stored in the nonvolatile memory 100. The second core 230 may check a map caching count of a subregion corresponding to the received logical address LBAa with reference to the map caching count table (MCCT) 225 stored in the memory 220, and determine whether the map caching count is greater than or equal to a threshold count.

When the map caching count is greater than or equal to the threshold count, the second core 230 may determine that upload of a map segment corresponding to the subregion is necessary, and transmit, to the first core 210, the determination result, that is, information INF_MU indicating that it is necessary to upload map data. On the basis of the information INF_MU received from the second core 230, the first core 210 may transmit, to the host, a response RES_NR_MU to the normal read command CMD_NR to which a map data upload request is added. The host 20 may transmit a map read command to the storage device 10 on the basis of the received response RES_NR_MU.

The map upload operation may be performed in response to the map read command. As described above, the second core 230 may read corresponding map data from the nonvolatile memory 100 in response to the map read command, encode the read map data, and store the encoded map data in the map uploading buffer 223 of the memory 220. In accordance with an embodiment, the second core 230 may read corresponding map data from the map caching buffer 221 in response to the map read command, encode the read map data, and store the encoded map data in the map uploading buffer 223 of the memory 220.

Although not illustrated in FIG. 6, when the map caching count is less than the threshold count, the second core 230 may determine that it is not necessary to upload the map segment corresponding to the subregion, and transmit, to the first core 210, information indicating that it is not necessary to upload the map data. On the basis of the information received from the second core 230, the first core 210 may transmit a normal response to the normal read command CMD_NR to the host. For example, the normal response may be a response not including the map data upload request.

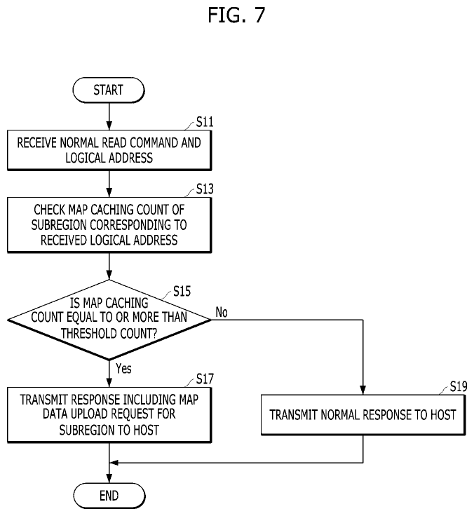

FIG. 7 is a diagram illustrating an operating method of the storage device 10 in accordance with an embodiment. In describing the operating method of the storage device in accordance with the present embodiment with reference to FIG. 7, at least one of FIG. 1 to FIG. 6 may be referred to.

In operation S11, a normal read command and a logical address may be received from the host. For example, the normal read command may be for reading user data stored in the nonvolatile memory 100.

In operation S13, the controller 200 of the storage device 10 may check a map caching count of a subregion corresponding to the logical address received from the host. For example, the controller 200 may check the map caching count of the subregion with reference to the map caching count table (MCCT) 225 stored in the memory 220.

In operation S15, the controller 200 may determine whether the map caching count checked in operation S13 is greater than or equal to a threshold count. When the map caching count is greater than or equal to the threshold count, the process may proceed to operation S17. When the map caching count is less than the threshold count, the process may proceed to operation S19.

In operation S17, the controller 200 may transmit, to the host, a response including a map data upload request for the subregion (that is, the subregion corresponding to the logical address received from the host) as a response to the normal read command received in operation S11.

In operation S19, the controller 200 may transmit a normal response to the normal read command received in operation S11 to the host. For example, the normal response may be a response not including the map data upload request.

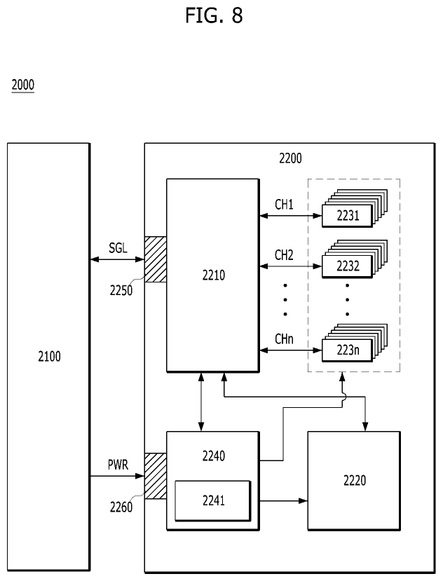

FIG. 8 illustrates a data processing system including a solid state drive (SSD) in accordance with an embodiment. Referring to FIG. 8, a data processing system 2000 may include a host apparatus 2100 and an SSD 2200.

The SSD 2200 may include a controller 2210, a buffer memory device 2220, nonvolatile memory devices 2231 to 223n, a power supply 2240, a signal connector 2250, and a power connector 2260.

The controller 2210 may control overall operation of the SSD 2220.

The buffer memory device 2220 may temporarily store data to be stored in the nonvolatile memory devices 2231 to 223n. The buffer memory device 2220 may temporarily store data read from the nonvolatile memory devices 2231 to 223n. The data temporarily stored in the buffer memory device 2220 may be transmitted to the host apparatus 2100 or the nonvolatile memory devices 2231 to 223n according to control of the controller 2210.

The nonvolatile memory devices 2231 to 223n may be used as a storage medium of the SSD 2200. The nonvolatile memory devices 2231 to 223n may be coupled to the controller 2210 through a plurality of channels CH1 to CHn, respectively. In another embodiment, more than one nonvolatile memory device may be coupled to the same channel, in which case there may be a lesser number of channels than memory devices. The nonvolatile memory devices coupled to the same channel may be coupled to the same signal bus and the same data bus.

The power supply 2240 may provide power PWR input through the power connector 2260 to the inside of the SSD 2200. The power supply 2240 may include an auxiliary power supply 2241. The auxiliary power supply 2241 may supply the power so that the SSD 2200 is properly terminated even when sudden power-off occurs. The auxiliary power supply 2241 may include large capacity capacitors capable of charging the power PWR.

The controller 2210 may exchange a signal SGL with the host apparatus 2100 through the signal connector 2250. The signal SGL may include a command, an address, data, and the like. The signal connector 2250 may be configured as any of various types of connectors according to an interfacing method between the host apparatus 2100 and the SSD 2200.

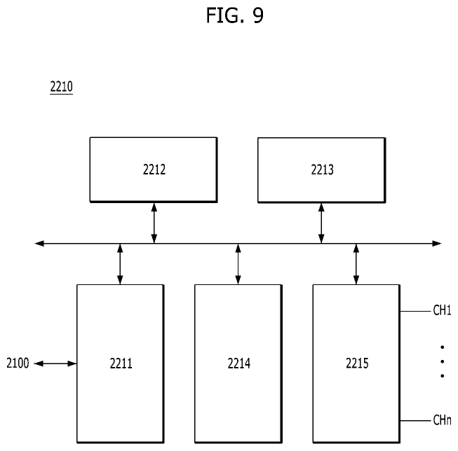

FIG. 9 illustrates the controller 2210 of FIG. 8. Referring to FIG. 9, the controller 2210 may include a host interface 2211, a control component 2212, a random access memory (RAM) 2213, an error correction code (ECC) component 2214, and a memory interface 2215.

The host interface 2211 may perform interfacing between the host apparatus 2100 and the SSD 2200 according to a protocol of the host apparatus 2100. For example, the host interface 2211 may communicate with the host apparatus 2100 through any among a secure digital protocol, a universal serial bus (USB) protocol, a multimedia card (MMC) protocol, an embedded MMC (eMMC) protocol, a personal computer memory card international association (PCMCIA) protocol, a parallel advanced technology attachment (PATA) protocol, a serial advanced technology attachment (SATA) protocol, a small computer system interface (SCSI) protocol, a serial attached SCSI (SAS) protocol, a peripheral component interconnection (PCI) protocol, a PCI Express (PCI-E) protocol, and/or a universal flash storage (UFS) protocol. The host interface 2211 may perform a disc emulation function such that the host apparatus 2100 recognizes the SSD 2200 as a general-purpose data storage apparatus, for example, a hard disc drive HDD.

The control component 2212 may analyze and process the signal SGL input from the host apparatus 2100. The control component 2212 may control operations of internal functional blocks according to firmware and/or software for driving the SDD 2200. The RAM 2213 may be operated as a working memory for driving the firmware or software.

The ECC component 2214 may generate parity data for the data to be transferred to the nonvolatile memory devices 2231 to 223n. The generated parity data may be stored in the nonvolatile memory devices 2231 to 223n together with the data. The ECC component 2214 may detect errors for data read from the nonvolatile memory devices 2231 to 223n based on the parity data. When the number of detected errors is within a correctable range, the ECC component 2214 may correct the detected errors.

The memory interface 2215 may provide a control signal such as a command and an address to the nonvolatile memory devices 2231 to 223n according to control of the control component 2212. The memory interface 2215 may exchange data with the nonvolatile memory devices 2231 to 223n according to control of the control component 2212. For example, the memory interface 2215 may provide data stored in the buffer memory device 2220 to the nonvolatile memory devices 2231 to 223n or provide data read from the nonvolatile memory devices 2231 to 223n to the buffer memory device 2220.

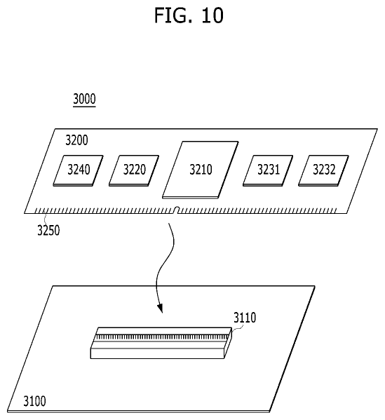

FIG. 10 illustrates a data processing system including a data storage apparatus in accordance with an embodiment. Referring to FIG. 10, a data processing system 3000 may include a host apparatus 3100 and a data storage apparatus 3200.

The host apparatus 3100 may be configured in a board form such as a printed circuit board (PCB). Although not shown in FIG. 10, the host apparatus 3100 may include internal functional blocks configured to perform functions of the host apparatus 3100.

The host apparatus 3100 may include a connection terminal 3110 such as a socket, a slot, or a connector. The data storage apparatus 3200 may be mounted on the connection terminal 3110.

The data storage apparatus 3200 may be configured in a board form such as a PCB. The data storage apparatus 3200 may refer to a memory module or a memory card. The data storage apparatus 3200 may include a controller 3210, a buffer memory device 3220, nonvolatile memory devices 3231 to 3232, a power management integrated circuit (PMIC) 3240, and a connection terminal 3250.

The controller 3210 may control overall operation of the data storage apparatus 3200. The controller 3210 may have the same configuration as the controller 2210 illustrated in FIG. 9.

The buffer memory device 3220 may temporarily store data to be stored in the nonvolatile memory devices 3231 and 3232. The buffer memory device 3220 may temporarily store data read from the nonvolatile memory devices 3231 and 3232. The data temporarily stored in the buffer memory device 3220 may be transmitted to the host apparatus 3100 or the nonvolatile memory devices 3231 and 3232 according to control of the controller 3210.

The nonvolatile memory devices 3231 and 3232 may be used as a storage medium of the data storage apparatus 3200.

The PMIC 3240 may provide power input through the connection terminal 3250 to the inside of the data storage apparatus 3200. The PMIC 3240 may manage the power of the data storage apparatus 3200 according to control of the controller 3210.

The connection terminal 3250 may be coupled to the connection terminal 3110 of the host apparatus 3100. A signal such as a command, an address, and data and power may be transmitted between the host apparatus 3100 and the data storage apparatus 3200 through the connection terminal 3250. The connection terminal 3250 may be configured in any of various forms according to an interfacing method between the host apparatus 3100 and the data storage apparatus 3200. The connection terminal 3250 may be arranged in or on any side of the data storage apparatus 3200.

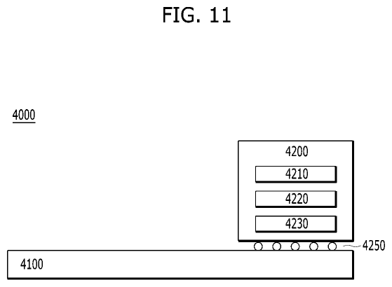

FIG. 11 illustrates a data processing system including a data storage apparatus in accordance with an embodiment. Referring to FIG. 11, a data processing system 4000 may include a host apparatus 4100 and a data storage apparatus 4200.

The host apparatus 4100 may be configured in a board form such as a PCB. Although not shown in FIG. 11, the host apparatus 4100 may include internal functional blocks configured to perform functions of the host apparatus 4100.

The data storage apparatus 4200 may be configured in a surface mounting packaging form. The data storage apparatus 4200 may be mounted on the host apparatus 4100 through a solder ball 4250. The data storage apparatus 4200 may include a controller 4210, a buffer memory device 4220, and a nonvolatile memory device 4230.

The controller 4210 may control overall operation of the data storage apparatus 4200. The controller 4210 may have the same configuration as the controller 2210 illustrated in FIG. 9.

The buffer memory device 4220 may temporarily store data to be stored in the nonvolatile memory device 4230. The buffer memory device 4220 may temporarily store data read from the nonvolatile memory device 4230. The data temporarily stored in the buffer memory device 4220 may be transmitted to the host apparatus 4100 or the nonvolatile memory device 4230 through control of the controller 4210.

The nonvolatile memory device 4230 may be used as a storage medium of the data storage apparatus 4200.

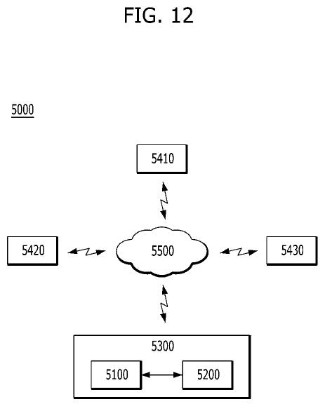

FIG. 12 illustrates a network system 5000 including a data storage apparatus in accordance with an embodiment. Referring to FIG. 12, the network system 5000 may include a server system 5300 and a plurality of client systems 5410 to 5430 which are coupled through a network 5500.

The server system 5300 may serve data in response to requests of the plurality of client systems 5410 to 5430. For example, the server system 5300 may store data provided from the plurality of client systems 5410 to 5430. In another example, the server system 5300 may provide data to the plurality of client systems 5410 to 5430.

The server system 5300 may include a host apparatus 5100 and a data storage apparatus 5200. The data storage apparatus 5200 may be configured of the storage device 10 of FIG. 1, the SSD 2200 of FIG. 8, the data storage apparatus 3200 of FIG. 10, or the data storage apparatus 4200 of FIG. 11.

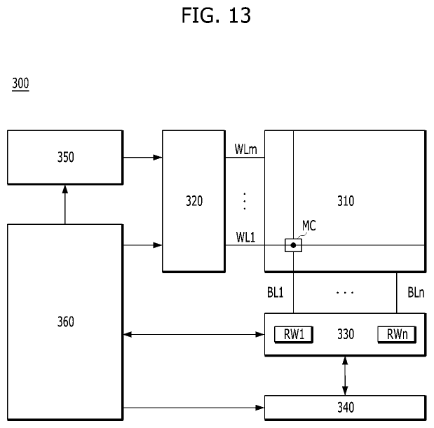

FIG. 13 illustrates a nonvolatile memory device included in a data storage apparatus in accordance with an embodiment. Referring to FIG. 13, a nonvolatile memory device 100 may include a memory cell array 110, a row decoder 120, a column decoder 140, a data read/write block 130, a voltage generator 150, and control logic 160.

The memory cell array 110 may include memory cells MC arranged in regions in which word lines WL1 to WLm and bit lines BL1 to BLn cross to each other.

The row decoder 120 may be coupled to the memory cell array 110 through the word lines WL1 to WLm. The row decoder 120 may operate through control of the control logic 160. The row decoder 120 may decode an address provided from an external apparatus (not shown). The row decoder 120 may select and drive the word lines WL1 to WLm based on a decoding result. For example, the row decoder 120 may provide a word line voltage provided from the voltage generator 150 to the word lines WL1 to WLm.

The data read/write block 130 may be coupled to the memory cell array 110 through the bit lines BL1 to BLn. The data read/write block 130 may include read/write circuits RW1 to RWn corresponding to the bit lines BL1 to BLn. The data read/write block 130 may operate according to control of the control logic 160. The data read/write block 130 may operate as a write driver or a sense amplifier according to an operation mode. For example, the data read/write block 130 may operate as the write driver configured to store data provided from an external apparatus in the memory cell array 110 in a write operation. In another example, the data read/write block 130 may operate as the sense amplifier configured to read data from the memory cell array 110 in a read operation.

The column decoder 140 may operate though control of the control logic 160. The column decoder 140 may decode an address provided from an external apparatus (not shown). The column decoder 140 may couple the read/write circuits RW1 to RWn of the data read/write block 130 corresponding to the bit lines BL1 to BLn and data input/output (I/O) lines (or data I/O buffers) based on a decoding result.

The voltage generator 150 may generate voltages used for an internal operation of the nonvolatile memory device 100. The voltages generated through the voltage generator 150 may be applied to the memory cells of the memory cell array 110. For example, a program voltage generated in a program operation may be applied to word lines of memory cells in which the program operation is to be performed. In another example, an erase voltage generated in an erase operation may be applied to well regions of memory cells in which the erase operation is to be performed. In another example, a read voltage generated in a read operation may be applied to word lines of memory cells in which the read operation is to be performed.

The control logic 160 may control overall operation of the nonvolatile memory device 100 based on a control signal provided from an external apparatus, i.e., a host. For example, the control logic 160 may control various operations of the nonvolatile memory device 100 such as a read operation, a write operation, an erase operation of the nonvolatile memory device 100.

While various embodiments have been illustrated and described, it will be understood by those skilled in the art that the disclosed embodiments are examples only. Accordingly, the present invention is not limited by or to any of the disclosed embodiments. Rather, the present invention encompasses all variations and modifications that fall within the scope of the claims.

What is claimed is:

1. A storage device comprising:
a nonvolatile memory including a plurality of memory regions; and
a controller configured to transmit to the host, when a normal read command and a logical address are received from a host, an upload request for uploading map data related to a first memory region corresponding to the logical address among the plurality of memory regions based on a map caching count related to the first memory region.

2. The storage device according to claim 1,
wherein the controller compares the map caching count related to the first memory region with a threshold count, and
wherein the controller transmits the upload request to the host when the map caching count is greater than or equal to the threshold count.

3. The storage device according to claim 1, further comprising: a memory configured to store some map data related to each of the plurality of memory regions.

4. The storage device according to claim 3, wherein the map caching count indicates a number of times that a map caching operation has been performed.

5. The storage device according to claim 3, wherein the memory stores a map caching count table including a map caching count for each of the plurality of memory regions.

6. The storage device according to claim 5, wherein the controller checks the map caching count of the first memory region with reference to the map caching count table.

7. The storage device according to claim 1, wherein the controller adds the upload request to a response to the normal read command and transmits the response to the host.

8. An operating method of a storage device including a nonvolatile memory including a plurality of memory regions and a controller, the operating method comprising:
receiving a normal read command and a logical address from a host; and
transmitting, to the host, an upload request for uploading map data related to a first memory region corresponding to the logical address among the plurality of memory regions based on a map caching count related to the first memory region.

9. The operating method according to claim 8, wherein the transmitting of the upload request to the host comprises a step of comparing the map caching count related to the first memory region with a threshold count.

10. The operating method according to claim 9, wherein the upload request is transmitted to the host when the map caching count related to the first memory region is greater than or equal to the threshold count.

11. The operating method according to claim 8, further comprising:
increasing the map caching count whenever the map data is read from the nonvolatile memory and stored in a memory in the controller.

12. The operating method according to claim 8, wherein the transmitting of the upload request to the host comprises: adding the upload request to a response to the normal read command.

13. A controller comprising:
a first core configured to serve as an interface with a host;
a memory configured to store a map caching count table including a map caching count for each of a plurality of memory regions included in a nonvolatile memory; and
a second core configured to determine, when a normal read command and a logical address are received from a host, whether to upload map data related to a first memory region corresponding to the logical address among the plurality of memory regions based on the map caching count related to the first memory region.

14. The controller according to claim 13,
wherein the second core checks the map caching count of the first memory region with reference to the map caching count table stored in the memory and compares the map caching count of the first memory region with a threshold count, and
wherein the second core determines whether to upload the map data related to the first memory region based on a result of the comparison.

15. The controller according to claim 14, wherein, when the map caching count related to the first memory region is greater than or equal to the threshold count, the second core transmits, to the first core, information indicating that the map data related to the first memory region is to be uploaded.

16. The controller according to claim 15, wherein the first core transmits to the host, based on the information received from the second core, a response to the normal read command, the response including an upload request for the map data related to the first memory region.

17. The controller according to claim 14, wherein the second core transmits to the first core, when the map caching count related to the first memory region is less than the threshold count, information indicating that the map data related to the first memory region is not map data to be uploaded.

18. The controller according to claim 17, wherein the first core transmits to the host, based on the information received from the second core, a response to the normal read command, the response excluding an upload request for the map data related to the first memory region.
